(19) United States
(12) Patent Application Publication
(10) Pub. No.: US 2006/0020724 A1
(43) Pub. Date: Jan. 26, 2006

(54) System and method for controlling a media player with a media controller

(75) Inventors: De-Hua Dang, Shenzhen (CN); Ming-Xiong Liao, Shenzhen (CN); Gang Liu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/148,590

(22) Filed: Jun. 9, 2005

(30) Foreign Application Priority Data
Jul. 23, 2004 (TW) 93122069

(51) Int. Cl. G06F 13/10

(52) U.S. Cl. 710/62

(57) ABSTRACT

A system for controlling a media player with a media controller includes a host computer (1), a media controller (11), and a Liquid Crystal Display (LCD) panel (12). The media controller is used for users to input commands of controlling the media player, and generating media control signals according to the commands. The LCD panel is used for displaying media information from a media player (6) installed in an operation system of the host computer. A motherboard (10) of the host computer includes: an audio DJ data processing module (103) for receiving media control signals, transforming the media control signals to audio DJ data, and sending the audio DJ data through a south bridge (102) to the media player to play media; and an LCD controlling module (104) for receiving and processing media information, controlling the media information to be displayed on the LCD panel. A related method is also disclosed.

### BACKGROUND OF THE INVENTION

1. Field of the Invention

The present invention relates to systems and methods for controlling a computer program, and more particularly to a system and method for controlling a media player in an operation system by utilizing an audio DJ technique.

2. General Background

Computers are now frequent sights in the home and workplace. As people spent more time on their computers, there have been a great number of demands for computerization of traditional types of media, such as songs, pictures, and movies. Due to recent advances in technology, computer users are now able to enjoy many features that provide an improved user experience, such as playing various media and multimedia content on their personal or laptop computers. For example, most computers today are able to play compact discs (CDs), so users can listen to their favorite musical artists while working on their computers. Additionally, many computers are equipped with digital versatile disc (DVD) drives enabling users to watch movies.

As users become more familiar with advanced features on their computers, such as those mentioned above, their expectations of the various additional innovative features will undoubtedly continue to grow. For example, consider a media player software application that enables a user to play a CD on their computer. Typical applications allow the user to display track information associated with the CD by clicking on an appropriate user interface (UI). Such track information usually includes track numbers, song titles, playing times, and the like. Notwithstanding these advances, the user will continue to desire further advancements, creative use of metadata associated with the digital media, to improve the experience.

Computers can be used to utilize multimedia player software to play audio music CDs in an operating system (OS) such as Windows. However, current demands show that users desire to operate media player while the computer system is power-off or running other applications. Operating the media player during the power-off state is commonly called as “Audio DJ function”, which is fairly user friendly, and provides an easy and convenient way for users to enjoy the multimedia function.

What is needed, therefore, is a system for controlling a software application, such as a media player loaded in a Windows OS of a computer, which provides an easy and convenient way for users to enjoy the multimedia function.

Similarly, what is also needed is a method for controlling a software application, such as a media player loaded in a Windows OS of a computer, which provides an easy and convenient way for users to enjoy the multimedia function.

### SUMMARY

A system for controlling a media player with a media controller in accordance with a preferred embodiment includes a host computer, a display, an audio output device, a keyboard, and a mouse. The host computer includes a media controller, a Liquid Crystal Display (LCD) panel and a motherboard. The media controller and the LCD panel are both enhanced on a front panel of the host computer. The media controller is used for users to input commands of controlling the media player, and generating media control signals according to the commands. The LCD panel is used for displaying media information from the media player installed in an operation system (OS) of the host computer. The motherboard includes a Central Processing Unit (CPU), a South Bridge, an audio DJ data processing module, an LCD controlling module. The audio DJ data processing module is used for receiving the media control signals from the media controller, transforming the media control signals to audio DJ data, and sending the audio DJ data through the south bridge to the media player to play media according to the commands. The LCD controlling module is used for receiving and processing the media information, and controlling the media information to be displayed on the LCD panel or the display. The media information includes song titles, playing statues, played time, volume, and system time.

Another preferred embodiment provides a method for controlling a media player loaded in an OS of a computer with a media controller. The method includes the steps of: (a) starting an OS, such as a windows OS; (b)executing a media monitoring program; (c) invoking an audio DJ service thread to process audio DJ data; (d) inputting media control commands for controlling the media player installed in the windows OS; (e) generating media control signals according to the commands; (f) transforming the media control signals to audio DJ data, and storing the audio DJ data in a system queue; (g) determining whether there are audio DJ data in the system queue; (h) setting the audio DJ service thread in a state of sleep to wait for receiving the audio DJ data, if there are no audio DJ data in the system queue; (i) determining whether the audio DJ data is an end command for stopping the media player, if there are audio DJ data in the system queue; (j) closing the audio DJ service thread to end the procedure, if the audio DJ data is an end command for stopping the media player; (k) sending the audio DJ data to the media player, if the audio DJ data is not an end command for stopping the media player; (1) playing media according to the audio DJ data; (m) transmitting the media information to an LCD panel; and (n) controlling the media information to be displayed on the LCD panel.

In summary, the system and method can control the media player loaded in the OS to play media, and display the media information on the LCD panel enchased on the front panel of the computer.

Other advantages and novel features of the embodiments will be drawn from the following detailed description with reference to the attached drawings, in which:

### BRIEF DESCRIPTION OF THE DRAWINGS

FIG. 1 is a schematic diagram of a computer system for controlling a media player with a media controller according to a preferred embodiment of the present invention;

FIG. 2 is a schematic diagram of the media controller of FIG. 1;

FIG. 3 is a schematic diagram of internal infrastructure of the host computer of FIG. 1;

FIG. 4 illustrates main data interchanges between components of the system of FIG. 1;

FIG. 5 is a schematic diagram of a layered structure of the audio DJ processing module of FIG. 3; and

FIG. 6 is a flowchart of a preferred method for controlling a media player by implementing the system of FIG. 1.

### DETAILED DESCRIPTION OF THE EMBODIMENTS

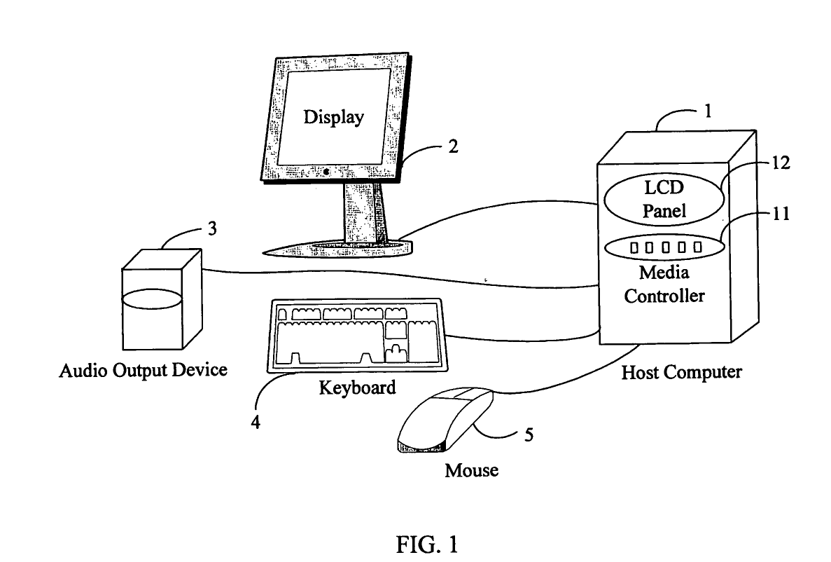

FIG. 1 is a schematic diagram of a computing system of an electronic device like a computer for controlling a media player of the computer with a media controller (hereinafter, “the system”) according to a preferred embodiment of the present invention. The system includes: a host computer 1, a display 2, an audio output device 3, a keyboard 4, and a mouse 5. The host computer 1 includes a media controller 11 and a Liquid Crystal Display (LCD) panel 12, which are both enchased on a front panel of the host computer 1. The media controller 11 may be several function buttons, a knob or any other controller known in the art, for users to input commands of controlling the media player and generating media control signals according to the commands. The LCD panel 12 is used for displaying media information, such as song titles, playing status, played time, volume, system time, etc. The display 2 can also be used for displaying the media information.

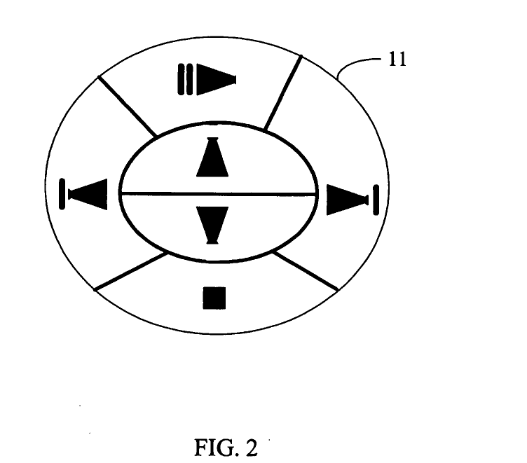

FIG. 2 is a schematic diagram of the media controller 11. In one preferred embodiment, the media controller 11 includes six function keys: a song playing on/off key (▪) , a song play/pause key (|| [symbol] ), a song forward key (| [symbol] ), a song back key ( [symbol] |), a volume increasing key (▴), and a volume decreasing key (▾). Table 1 lists command encodings of these function keys and their corresponding functions.

TABLE 1

| Sequence Number | Encoding | Function | Icon |
|---|---|---|---|
| 00 | 0X00 | Play on/off song | ▪ |
| 01 | 0X01 | Play/Pause song | [symbol] |
| 02 | 0X02 | Forward song | [symbol] |
| 03 | 0X03 | Back song | [symbol] |
| 04 | 0X04 | Increase volume | ▴ |
| 05 | 0X05 | Decrease volume | ▾ |

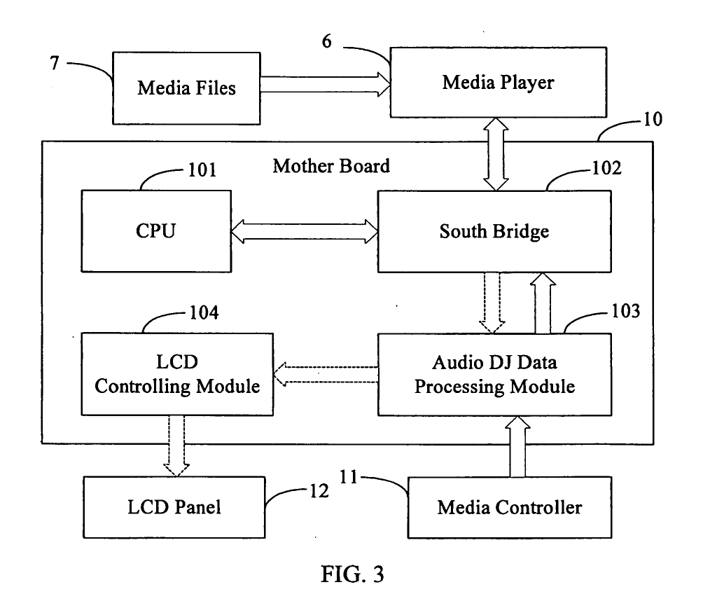

FIG. 3 is a schematic diagram of internal infrastructure of the host computer 1 in accordance with the preferred embodiment. A motherboard 10 of the host computer 1 includes a Central Processing Unit (CPU) 101, a South Bridge 102, an audio DJ data processing module 103, and an LCD controlling module 104. A media player 6 is installed in an operation system (OS) of the host computer 1, such as a Windows media player, an MP3, or a Real-player. Media files 7 are stored in CD/DVD drives or hard disk drives of the host computer 1 (not shown), for providing media data to the media player 6. The connections of these components are clearly illustrated in FIG. 3. The audio DJ data processing module 103 is used for receiving media control signals from the media controller 11, analyzing and decoding the media control signals to audio DJ data, and sending the audio DJ data through the south bridge 102 to the media player 6, in order to invoke and control the media player 6 to play the media files 7. The LCD controlling module 104 is used for receiving and processing media information from the media player 6, and controlling the media information to be displayed on the LCD panel 12.

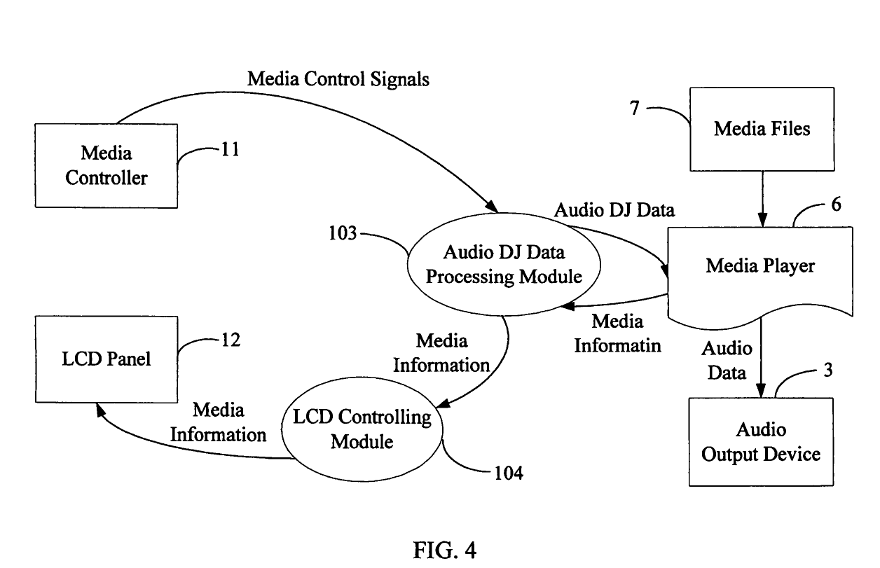

FIG. 4 illustrates main data interchanges between various components of the system. First, the media controller 11 generates media control signals according to commands for controlling the media player 6 inputted by a user, and transmits the media control signals to the audio DJ data processing module 103. The audio DJ data processing module 103 receives the media control signals, analyzing and decoding the media control signals to audio DJ data, and sends the audio DJ data through the south bridge 102 to the media player 6 to respond to the commands. The media player 6 reads media data from media files 7, and outputs media information to the audio DJ data processing module 103, and outputs audio data to the audio output device 3 simultaneously. The LCD controlling module 104 receives the media information from the audio DJ data processing 103, and controls the media information to be displayed on the LCD panel 12 or on the display 2. The media information includes song titles, playing status, played time, volume, system time, etc.

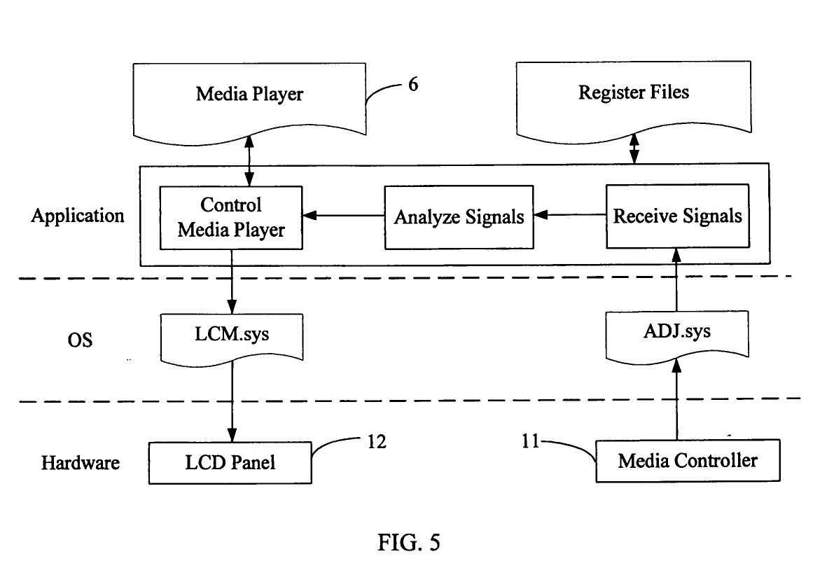

FIG. 5 is a schematic diagram of layered structure of the audio DJ data processing module 103. The audio DJ processing module 103 performs three main functions including: receiving media control signals from the media controller 11, analyzing and decoding the media control signals, and invoking and controlling the media player 6. The media controller 11 and the LCD panel 12 locate in a hardware layer. ADJ.sys and LCM.sys locate in an OS layer. ADJ.sys is a special document used for processing the media control signals, and LCM.sys is another special document used for processing and controlling the media information to be displayed on the LCD panel 12 or on the display 2. The media player 6 and register files locate in an application layer. The media controller 11 first generates the media control signals according to user-input commands for controlling the media player 6, and transmits the media control signals to the OS layer. The Windows OS automatically modifies the register files to respond to the commands. Simultaneously, the audio DJ data processing module 103 executes ADJ.sys to transform the media control signals to audio DJ data, transmits the audio DJ data to the media player 6, and transmits the media information to LCM.sys of the OS layer. Then, the LCD controlling module 104 executes LCM.sys to control the media information to be displayed on the LCD panel 12 or on the display 2.

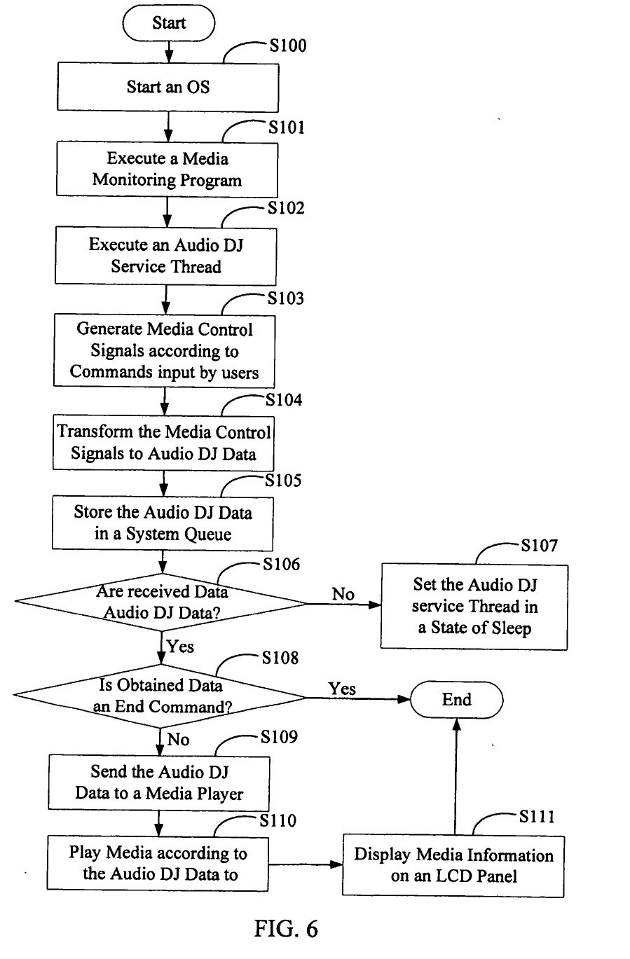

FIG. 6 is a flowchart of a preferred method for controlling a media player with a media controller by implementing the system. In step S100, the host computer 1 starts an OS, such as a Windows OS. In step S101, the Windows OS executes a media monitoring program pre-stored in the audio DJ data processing module 103, for continuously monitoring media control signals received from the media controller 11. In step S102, the media monitoring program invokes an audio DJ service thread. The audio DJ service thread is a program being executed in the Windows OS of the host computer 1 for processing the audio DJ data. In step S103, the media controller 11 generates corresponding media control signals according to commands for controlling the media player 6 inputted by a user, and transmits the media control signals to the audio DJ data processing module 103. In step S104, the audio DJ data processing module 103 receives the media control signals, transforms the media control signals to audio DJ data, In step S105, the audio DJ data processing module stores the audio DJ data in a system queue. In step S106, the audio DJ service thread determines whether there are audio DJ data in the system queue. The system queue may have other information on other running programs besides the audio DJ data. If there are no audio DJ data in the system queue, in step S107, the audio DJ service thread is set in a state of sleep to wait for the audio DJ data. Otherwise, if there are audio DJ data in the system queue, in step of S108, the audio DJ service thread determines whether the audio DJ data is an end command for stopping the media player 6. If the audio DJ data is an end command, the media monitoring program closes the audio DJ service thread, whereupon the procedure is ended. Otherwise, if the audio DJ data is not an end command, in step S109, the audio DJ service thread sends the audio DJ data to the media player 6. In step S110, the media player 6 plays media according to the audio DJ data, and transmits the media information to the LCD controlling module 104 through the audio DJ data processing module 103. In step S111, the LCD controlling module 104 controls the media information to be displayed on the LCD panel 12 or on the display 2.

Although the present invention has been specifically described on the basis of a preferred embodiment and preferred method, the invention is not to be construed as being limited thereto. Various changes or modifications may be made to the embodiment and method without departing from the scope and spirit of the invention.

We claim:

1. A system for controlling a media player, comprising:
a media controller for users to input commands of controlling the media player and generating media control signals according to the commands; and
a host computer comprising:
an audio DJ data processing module for receiving the media control signals, transforming the media control signals to audio DJ data, and sending the audio DJ data in order to control the media player; and
a Liquid Crystal Display (LCD) module for receiving and processing media information, and controlling the media information to be displayed on an LCD panel.

2. The system according to claim 1, wherein the media controller is enchased on a front panel of the host computer.

3. The system according to claim 1, wherein the LCD panel is enchased on the front panel of the host computer.

4. The system according to claim 1, wherein the media controller comprises six function keys: a song playing on/off key, a song play/pause key, a song forward key, a song back key, a volume increasing key, and a volume decreasing key.

5. The system according to claim 1, wherein the media information can also be displayed on a display.

6. A method for controlling a media player loaded in an operating system of a computer with a media controller, the method comprising the steps of:
starting an operation system (OS);
executing a media monitoring program;
invoking an audio DJ service thread to process audio DJ data;
inputting media control commands for controlling the media player;
generating media control signals according to the commands;
transforming the media control signals to audio DJ data;
storing the audio DJ data in a system queue;
determining whether there are audio DJ data in the system queue;
sending the audio DJ data to the media player;
playing media according to the audio DJ data;
transmitting media information to a display; and
displaying the media information on the display.

7. The method according to claim 6, wherein the step of determining whether there are audio DJ data in the system queue comprises the step of setting the audio DJ service thread in a state of sleep to wait for the audio DJ data, if there are no audio DJ data in the system queue.

8. The method according to claim 6, wherein the step of determining whether there are audio DJ data in the system queue comprises the step of determining whether the audio DJ data is an end command for stopping the media player, if there are audio DJ data in the system queue.

9. The method according to claim 8, wherein the step of determining whether the audio DJ data is an end command comprises the step of the media monitoring program closing the audio DJ service to end the procedure, if the audio DJ data is an end command.

10. The method according to claim 6, wherein the media information include song titles, playing status, played time, volume, and system time.

11. A method for playing media files by means of a media player of an electronic device, comprising the steps of:
starting an operation system (OS) in said electronic device;
programming said media player of said electronic device to be operable independently based on said OS;
retrieving user's control commands for controlling said media player;
generating audio DJ data according to said user's commands;
playing said media files via said media player according to said audio DJ data;
generating media information related to said media files according to said audio DJ data; and
displaying said media information on a display for said media player.
